(19) United States
(12) Patent Application Publication
(10) Pub. No.: US 2017/0003178 A1
(43) Pub. Date: Jan. 5, 2017

(54) METHOD AND APPARATUS FOR DETERMINING THE SKIN TEMPERATURES OF HEAT-EXCHANGE TUBES IN A FIRED TUBULAR GAS HEATER

(71) Applicants: HYL TECHNOLOGIES, S.A. DE C.V., San Nicolas de los Garza (MX); DANIELI & C. OFFICINE MECCANICHE S.p.A., Buttrio (IT); NUCOR STEEL LOUISIANA, LLC, Convent, LA (US)

(72) Inventors: Jorge-Octavio BECERRA-NOVOA, Monterrey (MX); Maria-Teresa Guerra-Reyes, Monterrey (MX); Anthony Ramjewan, Baton Rouge, LA (US); Alessandro Martinis, Pozzuolo del Friuli (UD) (IT)

(73) Assignees: HYL TECHNOLOGIES, S.A. DE C.V., San Nicolas de los Garza (MX); DANIELI & C. OFFICINE MECCANICHE S.p.A., Buttrio (IT); NUCOR STEEL LOUISIANA, LLC, Convent, LA (US)

(21) Appl. No.: 15/199,719

(22) Filed: Jun. 30, 2016

Related U.S. Application Data
(60) Provisional application No. 62/187,116, filed on Jun. 30, 2015.

(51) Int. Cl. G01K 13/00

(52) U.S. Cl. CPC G01K 13/00

(57) ABSTRACT

Method and apparatus to determine the skin-temperature of heat-exchange tubes and to prevent overheating of the heat-exchange tubes in a process gas heater (where extreme conditions prevent obtaining sufficiently-accurate direct thermocouple or pyrometric measurement to reliably prevent such overheating) by calculating the maximum skin temperature of heat-exchange tubes using preferably real-time calculation of the overall heat flux through the walls of the heat-exchange tubes with preferably real-time values of gas composition and gas temperature at the inlet and at the outlet of the tubes to calculate the overall transferred heat; and by periodically measuring the temperature of the gas flowing through each of the heat-exchange tubes, and using the measured gas temperatures for calculating the skin-temperature of all tubes, or of a tube selected for the highest gas temperature using the equation:

$$Q = 2 π L ( Ts - Tg ) / ( \frac{ln \frac{ro}{ri}}{Km} ) .$$

The highest value of skin-temperature can be used to take corrective actions to avoid tubes overheating.

### FIELD OF THE INVENTION

The invention relates to the field of industrial plants where a gas stream is heated in a tubular heater by heat exchange through the walls of heat-exchange tubes and wherein the process gas being heated passes through said tubes receiving heat from the combustion of a fuel outside of said heating tubes.

### BACKGROUND OF THE INVENTION

Fuel fired tubular process-gas heaters are used in a number of industrial processes to raise the temperature of a fluid (such as a process gas, which after heating is processed or used in other parts of the plant. Examples of this type of industrial processes are petrochemical reforming processes (such as in U.S. Pat. No. 4,400,784) and direct reduced iron (DRI) plants (such as in U.S. Pat. Nos. 4,528,030; 5,858,057).

In order to heat a gas to high temperatures, for example above 800° C. and preferably above 900° C. in a DRI production plant, the gas is heated in a direct fired tubular heater having a series of heat-exchanging tubes wherein the process gas to be heated passes through the heating tubes and a series burners typically located in the heater floor produce heat by a fuel combustion, typically natural gas. The heat released by the fuel combustion is transferred to the gas mostly by radiation through the wall of high-alloy tubes distributed over the volume of the heater.

In the operation of a gas heater, the skin temperature, e.g. the temperature of the metallic wall of the tubes is one of the most important parameters to watch and constantly monitor to prevent damage to the tubes by overheating, for example, deformation, rupture and severe damage to the whole structure of the heater which may cause extensive repair costs and long plant shut-downs.

The heater tubes have a maximum allowable temperature that the specific alloy of the tube may withstand therefore it is extremely important to not reach such maximum operating temperature. Several methods and devices to measure the tubes' skin temperature have been proposed in the past in the petrochemical industry, particularly related to catalytic reforming units for ethylene and gasoline production.

The applicants have found the following patents and technical publications related to determination of the tube wall temperatures, however none of the prior art methods or devices provide a reliable measurement of such temperature, mainly due to the extreme conditions in the heater radiation zone for installing thermocouples in the tubes.

U.S. Pat. No. 4,400,784 describes a method of calculating the maximum tube skin temperature for a petrochemical cracking furnace. The method is based on a model using specific constants derived from the operation of the furnace using the equation:

Tmax=A₀+(B₀)(Fx)(CONV)+(B₁)(C₃)+(B₂)(C₂)

where: Tmax=maximum tube skin temperature in the furnace; Fx=Flow rate of the feed flowing through the furnace; CONV=percent conversion of propane in the feed; C332 Concentration of propane in the feed; C2=Concentration of ethane in the feed; and A₀, B₀, B₁ and B₂=constants. The values of constants A₀, B₀, B₁ and B₂ are determined by polynomial regression from data taken by actually measuring the skin temperature of the tubes at different flow rates of feed and at different percentage conversions and propane and ethane concentrations. This method has a number of disadvantages. The method needs measurement of the skin temperature of the tubes, which presents a high degree of inaccuracy. If a pyrometer is used, the hot gases of the flames inside the furnace cause that the reading of the instrument may be way off the actual temperature. If it is done by a thermocouple attached to the tubes, it must be located outside of the furnace because of the high temperature inside the firebox of the heater, and therefore the temperature of the tube will be affected by the cooling effect of the tube portion outside of the firebox. This method is not reliable to be used as an on-line tool for a furnace operation because it is based on a set of relationships of the process variables of the plant which do not take into account actual changes in the operation. The reliability of the method depends on values selected from the past and not the current situation of the furnace. The present invention in contrast provides a reliable method for calculating the tubes' skin temperature using actual determination of the heat flux that is transferred to the heated fluid and actual measurements of the gas flow rate and temperature of the heated gas.

The Article “Tube Skin Temperature Prediction of Catalytic Reforming Unit (CRU) Heaters” by Suzana Yusup et al. published in the Proceedings of the 5^{th} WSEAS Int. Conf. on DATA NETWORKS, COMMUNICATIONS & COMPUTERS, Bucharest, Romania, Oct. 16-17, 2006, describes a simulation of the tube skin temperatures of CRU heaters and temperature distribution across the heater tubes. The authors carried out such simulation using finite element approach. The method of finite elements is much more complicated and requires significant computing resources and specialized software, while the present invention is based on an overall heat balance of the heat transferred to the heated gas and the heat released by the burners of the heater to calculate the actual in-line heat flux and from said measurements the temperature of the metallic wall of the tubes is calculated.

U.S. Pat. No. 5,172,979 is here cited for a background of the difficulties found when a direct measurement of the skin temperatures is attempted, and discloses a skin thermocouple assembly comprising a block forming a heat shield to said thermocouple and preventing it from becoming a fin for heat exchange which would affect the accuracy and reliability of the temperature measurement. Barkley describes some of the problems related to the use of thermocouples for monitoring said tube skin temperature. This patent does not disclose or suggest the method and apparatus of the present invention wherein the thermocouples are utilized to measure the temperature of the gases circulating through the tubes but not for measuring the temperature of the metallic wall of said tubes.

U.S. Pat. No. 7,249,885 discloses a measuring device and a method to measure the heat flux in a heat exchanger. The method is characterized by providing an indentation in the tubes wall, a thermocouple is placed eccentrically in said indentation so that the heat flux is obstructed to a small degree by the tube wall and the local overheating of the tube is prevented. This patent proposes to use a heat flux sensor to study the behavior of a heater or boiler, and to control a combustion chamber.

U.S. patent application Ser. No. 20140316737 describes a method for real-time monitoring in-furnace wall temperature of the tube apparatus used in utility boilers comprising: performing a pre-calculation and choosing some tubes as representative tubes, installing wall temperature measuring points out of the furnace of the chosen tubes; reading data from a real-time database of a power plant and the out-of-furnace temperatures. The teachings of this patent however are not directly applicable to the type of gas heaters used in the direct reduction plants or the petrochemical industry because the range of operating temperatures of the steam re-heaters in boilers are considerably lower than the operating temperatures of the heaters used in direct reduction plants.

There is a not-yet-satisfied need for a reliable and accurate method and apparatus for determining the skin temperature of the tubes in a process gas heater of direct reduction plants or a petrochemical cracking furnace which can be used to prevent said tubes from reaching the maximum allowable operating skin temperatures and avoid equipment damage and economic losses.

The contents of the above references are incorporated in full by reference herein.

### OBJECTS OF THE INVENTION

It is therefore an object of the invention to provide an in-line method and apparatus for determining the skin temperature of heat-exchange tubes in a tubular gas heater with higher accuracy and reliability.

It is another object of the invention to provide an in-line method and apparatus useful for a safer operation of a tubular gas heater.

It is another object of the invention to provide an in-line method and apparatus for preventing overheating of the heat-exchange tubes of a fired tubular heater to avoid damage to said tubes and economic losses because of expensive repairs and plant shutdowns.

Other objects will be hereinafter pointed out or will be evident from the description of the invention.

### BRIEF DESCRIPTION OF THE DRAWINGS

FIG. 1 is diagrammatic perspective view of a direct fired heater showing an application of a preferred embodiment of the invention.

### DETAILED DESCRIPTION OF THE INVENTION

It is known that the gas heaters utilized in the DRI plant to raise the temperature of reducing gas to levels above 850° C., preferably above 950° C., are exposed to severe operating conditions, for example temperatures in the radiant zone above 1150° C., and unexpected start-stop cycles and also carburizing conditions inside the heat-exchange tubes. The radiant coils of heat-exchange tubes have a limited life and are subject to failures caused by many factors, for example, coke formation, creep ductility, thermal fatigue, brittle fracture, overheating.

One of the main process parameters to be watched is the maximum allowable skin temperature of the tubes. To this end, the tubes are periodically inspected to detect bulges, cracks, tubes bending, hot spots and gas leaks which may in extreme cases melt down the tubes and cause extensive damage.

The actual skin temperature of the tubes is typically measured using an infrared camera but the measurements with the pyrometer instruments are not reliable because the hot flue gases surrounding the tubes interfere with the detection of the light radiated from the tubes, therefore in practice the pyrometer measurements are only relative and may be used for comparing temperatures over time but cannot reliably provide an accurate temperature reading.

Direct temperature measurements using thermocouples attached to the walls of the heat-exchange tubes outside of the radiant zone 14 of the heater have also been tried but this method cannot provide an accurate temperature reading because the thermo-well acts as a heat sink or heat-transfer fin and alters the reading of the actual wall temperature. The harsh environment inside the radiant zone 14 does not allow the use of thermocouples for actual and reliable measurement of the tubes' skin temperature.

In one aspect of the present invention, it provides an in-line and reliable method capable of determining the actual real-time tube skin temperature of all or at least one of the tubes of a heater, and in another aspect of the invention, it comprises selecting and using the maximum value of said tubes skin temperatures to provide a signal that can be used by the plant operator or by an automatic control apparatus to take corrective actions in real-time and avoid overheating of the heat-exchange tubes. The method is based on the actual and accurate measurement of the flow rate, composition and temperature of the gas flowing through the heat exchange tubes at the inlet and outlet of the radiation zone of the heater to determine the actual value of the total amount of heat transferred to the gas stream heated through the walls of the heat-exchange tubes and using the value of said total amount of heat to calculate the skin temperature from the heat flux equation 1.

In another aspect of the invention, the invention comprises monitoring the gas temperature at the outlet of all, or of a plurality, of the tubes in the radiant zone, and using these preferably real-time measurements to determine the value for the highest tube skin temperature of said heat-exchange tubes; comparing said highest tube skin temperature with the maximum allowable tube skin temperature, whereby the operation of the gas heater can be always maintained within the recommended operating range of temperature. The maximum allowable tube skin temperature is determinable empirically; most practically with the help of stress graphs and other data available from the tube supplier. In this way, a warning signal may be produced to alert the operator of the gas heater when the difference between said highest value of skin temperature and said maximum allowable operational temperature is equal to or less than a predetermined value. In an exemplary embodiment of the invention, this predetermined value is between 10° C. and 15° C.

An automatic apparatus may be used for generating the warning signal related to the overheating of the heat-exchange tubes, which apparatus comprises a gas flow rate measuring device to generate a first signal indicative of the flow rate of the gas stream passing through said heat-exchange tube; a gas analyzer for determining the composition of said gas stream to generate a second signal indicative of the amounts of the constituents of said gas stream; a first temperature measuring device to generate a third signal indicative of the temperature of said gas stream before passing through said heat-exchange tubes; a plurality of second temperature measuring devices to generate a respective set of fourth signals indicative of the temperature of said gas stream after passing through each of said heat-exchange tubes; and a processing device for periodically calculating the value of skin temperature of each of said heat-exchange tubes using said first signal, said second signal, said third signal and said fourth signals and for selecting the highest value of the calculated skin temperatures to compare it with the maximum allowable operational temperature for said tubes to take corrective actions as needed to avoid overheating the tubes.

The method of the invention for calculating the skin temperature of the tubes is based on the actual total heat flux of the heater (derived from preferably real time measurements) using the following equation:

$$Q = 2 π L ( Ts - Tg ) / ( \frac{ln \frac{ro}{ri}}{Km} ) \qquad Equation 1$$

where
Q=BTU/hr=Heat transferred over the total area of the tubes calculated with equation 2
L=ft=Total length of all the heat-exchange tubes.
Ts=° C.=Skin temperature of a tube
Tg=° C.=Temperature of the gas at the exit of a heat-exchange tube
ri=ft=Internal radius of tube
ro=ft=External radius of tube
Km=BTU/hr-ft-° F.=Thermal conductivity of tube wall, usually provided by data from the tube supplier.

The total transferred heat Q is calculated using the actual measurement of the total gas flow rate F, composition Xi of the gas passing through the tubes, and the temperature at the inlet T₁ and outlet T₂ of the radiant zone of the heater, where the total heat Q is transferred, using the following equation:

$$Q = \sum FXi {\int }_{{T}_{1}}^{{T}_{2}} Cpi d T \qquad Equation 2$$

where
F=NCMH=Total gas flow rate
Xi=mole fraction of gas component i as analyzed in line
Cpi=J/(mole*° K)=Heat capacity of gas component i
T₁=° C.=gas temperature at inlet of radiant zone
T₂=° C.=gas temperature at outlet of radiant zone

The gas composition is obtained from actual analysis of the gas stream and the mole fraction of each component Xi is used with the heat capacity CPi of the respective gas stream component.

The foregoing equations 1 & 2 are not limited to use of only the metric or imperial units shown above in the definition of terms.

The main advantages of the invention over the prior art are:
(1) The invention is based on the calculation of the heat flux through the total surface of the heat-exchange tubes using reliable temperature measurements at the header feeding the gas to all the tubes and at the header collecting the hot gas from all the tubes. This total heat calculation avoids the problem of determining whether there is an uneven heat-transfer distribution in the radiant-zone which does not allow a reliable calculation of the heat flux for each single tube.
(2) There is a continuous in-line monitoring of the gas temperature at the exit of each tube and the invention uses only the highest temperature value to calculate the skin temperature enabling the operator or an automatic system to take corrective action.
(3) The invention uses the actual measurement of the temperature of the gas passing through the heat-exchange tubes which can reliably be made by thermocouples in contact with the gas, and not the temperature of the metal wall of the tubes.
(4) The thermocouples 40 measuring the gas temperature are located out of the radiant zone of the heater, close to the connection point of each tube with a header which conveys the hot gas out of the heater, thus providing a safe and reliable installation.

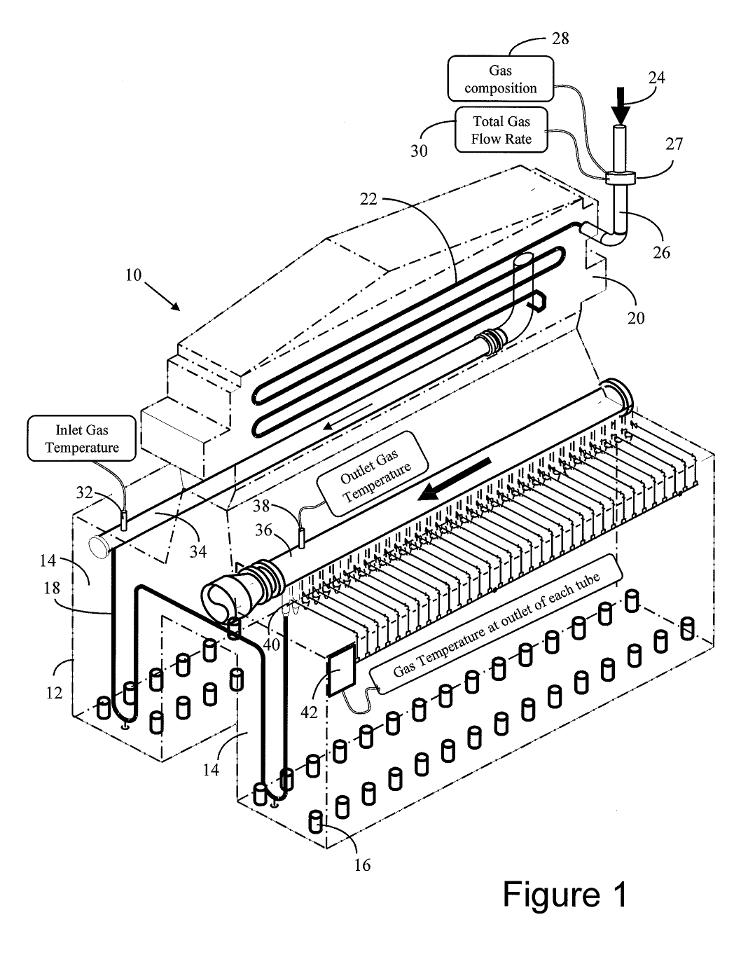

Referring to FIG. 1, where a schematic view of a gas heater is shown, numeral 10 generally designates a direct fired heater typically used in a DRI production plant to raise the temperature of a process gas to levels above 800° C. and preferably above 950° C., having a housing 12 shown in dash-dotted lines to simplify the drawing. The housing 12 may be made of a steel structure clad with refractory and insulating materials as is known in the art.

The heater 10 typically has one or two radiation zones 14, depending on the capacity and the heat duty of the heater, and a set of burners 16 usually located at the bottom of the housing where the combustion of a suitable fuel, typically natural gas, provides the heat to be transferred to the process gas circulating through a set of tube coils 18 being only one illustrated in the drawing for the sake of simplicity. The heat released by the burners is mainly transferred by radiation to the tubes 18 and the products of combustion flow upwardly to a stack (not shown) through a convection zone 20 where heat is transferred to a second set of coils 22, where only one has been illustrated for simplicity of the drawing, to preheat the gas 24 which is then heated in the radiation zone 14.

The stream of process gas 24 is fed to the convection coils 22 through a header 26. A sample of the process gas is taken from header 26 through sampling and measuring devices 27 and its composition is determined by gas analyzer 28. The gas composition and the specific heat capacity of each component of gas stream are used to calculate the actual heat capacity of the gas being heated. A flow rate meter 30 provides the amount of gas circulating through the heat-exchange tubes to determine the total heat transferred to the gas stream, e.g. the overall heat flux through the total heat-transfer area of the tubes.

The temperature of the gas stream is measured by a temperature-measuring device 32, for example a thermocouple installed at a suitable location in header 34, outside of the radiant zone 14, which collects the gas from the convection coils 22 and distributes it to the radiant heat-exchange tubes 18. This device 32 thus gives the inlet gas temperature for the radiation zone 14. The outlet gas temperature for the radiation zone 14 is measured at a suitable location, also outside of the radiant zone 14, at a header 36; which collects the heated gas stream to be fed to the reduction reactor, by a temperature-measuring device 38. Measurements from devices 32 and 38 are used in the calculation of the overall heat flux in the radiant zone of the heater.

Each of the tubes 18 has a temperature-measuring device 40 which measures the temperature of the gas stream at the outlet of each tube. The signals of the thermocouples 40 are transmitted to a processing device 42, which continuously monitors the temperature of the gas exiting each of the tubes 18, typically completing a monitoring cycle every 4 to 8 seconds, and selects the highest value identifying the selected tube. This temperature is used as the temperature of the gas: Tg in equation 1.

The overall heat-transfer area is calculated by summing up the heat-transfer areas of the tubes, which is equivalent to using the aggregate length L of all the tubes in the heater.

With all the above values, the tube skin temperature Ts is calculated from the above equation with very good accuracy. If Ts is close to the maximum operationally allowable skin temperature of the tubes by a difference less than a predetermined tolerance, a signal is generated for the plant operator or the plant control system to take corrective actions and prevent the heat-exchange tubes from reaching said maximum operationally allowable temperature.

In a DRI production plant, the process gas, which is heated before it is fed to the reduction reactor, is mainly composed of hydrogen and carbon monoxide, and also contains carbon dioxide, water, methane and smaller amounts of other hydrocarbons.

When the invention is applied in a tubular gas heater comprising heat-exchange tubes of different dimensions and/or different alloys, then it would be necessary to take into account the different values of length and internal and external radius to calculate the total heat transfer area and make the calculation using equation 3 for the different thermal conductivities for each type of alloy, thus enabling the operator or an automatic system to compare the maximum calculated skin temperature with the allowable operating temperature of the tubes of each type of alloy:

$$Q = 2 π \sum Ni Li ri ( Ts - Tg ) / ( \frac{ln \frac{ro}{ri}}{Kmi} ) \qquad Equation 3$$

where
Ni=number of tubes of alloy i
Li=Length of tubes of alloy i
ri=radius of tubes of alloy i
Kmi=thermal conductivity of alloy i

### EXAMPLE

The operational parameters provided for calculating Q the overall heat transferred through the tubes were:
F=52,000 NCMH=Total gas flow rate as measured in-line
T₁=500° C.=gas temperature at inlet of radiant zone
T₂=950° C.=gas temperature at outlet of radiant zone
   With the above data from measurements in the heater and the specific values of the dimensions of the tubes and the composition of the gas, using equation 2 the overall heat transferred through the tubes was calculated as 159,887 BTU/hr.

After calculation of the total transferred heat Q, the value of Q was used in Equation 1 to calculate Ts the tube skin temperature of the selected tube (having the highest gas temperature).

The following values of the variables in equation 1 were used:
L=ft=Total length of tubes
Tg=980° C.=Highest temperature of the gas at outlet of the tube selected from the values of temperature obtained from the monitoring cycle of all the heat-exchange tubes.
ri=0.365 ft=Internal radius of tubes
ro=0.409 ft=External radius of tubes
Km=16.36 BTU/(hr-ft-° F.)=Thermal conductivity of tube wall
   From equation 1, the value of Ts was obtained as 1,050° C.

This skin temperature may now be compared with the maximum allowable temperature for the tubes and provides the operator or an automatic system to take corrective measures, such as lowering the operation temperature of the heater or even shutting down the heater to determine the cause of the high skin temperature.

It is of course to be understood that the above description of the invention has included only some preferred embodiments, but that the scope and spirit of the invention is not limited to such embodiments but is defined in the appended claims. Although the invention has been illustrated and described as applied to a gas heater of a direct reduction plant, it will be evident to those skilled in the art that many changes may be made to better adapt the invention for a particular application, and that the applicability of the invention may be extended to other processes and plants where a tubular heater is used.

What is claimed is:

1. Method for determining the skin temperature of at least one heat-exchange tube of a fired tubular gas heater having a radiant zone, using a calculation of the overall heat flux through the wall of all said heat-exchange tube in said heater, said method being characterized by calculating the heat transferred to gas passing through said tube by using measured values of the temperature of said gas at or close to the tube's inlet to, and outlet from, the radiant zone, and the measured values of the flow rate and composition of said gas; and using the measured gas temperature at the outlet of said heat-exchange tube as well as the dimensions and thermal conductivity of said tube to calculate said skin temperature.

2. Method for determining the skin temperature of a heat-exchange tube according to claim 1, further characterized by calculating the heat (Q) transferred through the walls of said heat-exchange tube using the equation:
$$Q = \sum FXi {\int }_{{T}_{1}}^{{T}_{2}} Cpi d T$$
where
F=Total gas flow rate
Xi=mole fraction of gas component i as analyzed in line
Cpi=Heat capacity of gas component i
T₁=gas temperature at inlet of radiant zone
T₂=gas temperature at outlet of radiant zone
and calculating the skin temperature Ts of the tube using the equation:
$$Q = 2 π L ( Ts - Tg ) / ( \frac{ln \frac{ro}{ri}}{Km} )$$
where
Q=Heat transferred over the total area of the tubes calculated with equation 2
L=Total length of all the heat-exchange tubes.
Ts=Skin temperature of a tube
Tg=Temperature of the gas at the exit of a heat-exchange tube
ri=Internal radius of tube
ro=External radius of tube
Km=Thermal conductivity of tube wall provided by data from the tube supplier

3. Method for determining the highest value of skin temperature from among the temperatures of a plurality of heat-exchange tubes in a radiant zone of a fired tubular gas heater, which also has a first gas header located outside of said radiant zone and feeding gas to the heat-exchange tubes and a second gas header also located outside of said radiant zone and collecting the gas from said heat-exchange tubes, using a real-time calculation of the overall heat flux through the total area of the walls of all said heat-exchange tubes in said heater, said method being characterized by calculating the total heat transferred to the gas passing through said tubes by using measured values of the temperature of said gas at or close to the tube inlets to, and tube outlets from, the radiant zone, and the measured values of the flow rate and composition of said gas passing through said tubes; periodically measuring the temperature of the gas flowing through each of said tubes at a location close to the outlet of each one of said heat-exchange tubes; and using the measured gas temperature as well as the dimensions and thermal conductivity of said tubes to calculate said highest skin temperature.

4. Method for determining the highest value of skin temperature from among the temperatures of a plurality of heat-exchange tubes in a radiant zone of a fired tubular gas heater according to claim 3, further characterized by calculating the heat (Q) transferred through the walls of said heat-exchange tube using the equation:
$$Q = \sum FXi {\int }_{{T}_{1}}^{{T}_{2}} Cpi d T$$
where
F=Total gas flow rate
Xi=mole fraction of gas component i as analyzed in line
Cpi=Heat capacity of gas component i
T1=gas temperature at inlet of radiant zone
T2=gas temperature at outlet of radiant zone
and calculating the skin temperature Ts of each of the tubes using the equation:
$$Q = 2 π L ( Ts - Tg ) / ( \frac{ln \frac{ro}{ri}}{Km} )$$
where
Q=Heat transferred over the total area of the tubes calculated with equation 2
L=Total length of all the heat-exchange tubes.
Ts=Skin temperature of a tube
Tg=Temperature of the gas at the exit of a heat-exchange tube
ri=Internal radius of tube

5. Method for determining the highest skin temperature of a plurality of heat-exchange tubes according to claim 3, further characterized by using the highest gas temperature from the periodic measurement of the gas temperature at the outlet of each heat-exchange tube.

6. Method for preventing overheating of heat-exchange tubes in a tubular process gas heater, by calculating the skin temperature of a plurality of heat-exchange tubes using calculation of the overall heat flux through the walls of said heat-exchange tubes and values of gas composition and gas temperature at the inlet and at the outlet of the heat-exchange tubes to calculate the overall transferred heat; characterized by periodically measuring the temperature of gas flowing through each of said heat-exchange tubes at the outlet of said heat-exchange tubes, and selecting at least one of the measured temperatures of the gas exiting said tubes for calculating the skin temperature of the corresponding tube, and using the highest value of skin temperature to take corrective actions as needed to avoid overheating the tubes.

7. Method for preventing overheating of heat-exchange tubes in a tubular process gas heater according to claim 6, further characterized by calculating said heat (Q) transferred through the walls of said heat-exchange tube using the equation:
$$Q = \sum FXi {\int }_{{T}_{1}}^{{T}_{2}} Cpi d T$$
where
F=NCMH=Total gas flow rate
Xi=mole fraction of gas component i as analyzed in line
Cpi=Heat capacity of gas component i
T₁=gas temperature at inlet of radiant zone
T₂=gas temperature at outlet of radiant zone
And calculating the skin temperature Ts of each of the tubes using the equation:
$$Q = 2 π L ( Ts - Tg ) / ( \frac{ln \frac{ro}{ri}}{Km} )$$
where
Q=Heat transferred over the total area of the tubes calculated with equation 2
L=Total length of all the heat-exchange tubes.
Ts=Skin temperature of a tube
Tg=Temperature of the gas at the exit of a heat-exchange tube
ri=Internal radius of tube
ro=External radius of tube
Km=Thermal conductivity of tube wall provided by data from the tube supplier

8. Method for determining the skin temperature of heat-exchange tubes according to claim 6, further characterized by using the calculated maximum skin temperature for generating a signal used by an operator or an automatic system to take corrective actions by comparing the value of said calculated maximum skin temperature with a temperature set as the maximum allowable operational temperature of said heat-exchange tubes; and providing a signal to the operator or an automatic system controlling said gas heater when the difference between said value of skin temperature and said maximum allowable operational temperature is equal or less than a predetermined value.

9. Method for determining the skin temperature of heat-exchange tubes according to claim 8, further characterized by said difference between the predetermined value of calculated maximum skin temperature and said maximum allowable operational temperature is within the range of 10° C. to 15° C.

10. Apparatus for determining the skin temperature of at least one heat-exchange tube in a radiant zone of a fired tubular gas heater by using a calculation of the overall heat flux being transferred through the walls of said heat-exchange tube, said apparatus being characterized by comprising
a gas flow rate measuring device to generate a first signal indicative of the flow rate of a gas stream passing through said heat-exchange tube,
a gas analyzer for determining the composition of said gas stream to generate a second signal indicative of the amounts of constituents of said gas stream;
a first temperature measuring device to generate a third signal indicative of the temperature of said gas stream as or closely before passing into said radiant zone and on through said heat-exchange tube;
a second temperature measuring device to generate a fourth signal indicative of the temperature of said gas stream upon or closely after passing out of said radiant zone from said heat-exchange tube; and
one or more processing for calculating the value of said skin temperature of said heat-exchange tube using said first signal, said second signal, said third signal and said fourth signal.

11. Apparatus for determining the skin temperature of a heat-exchange tube according to claim 10, further characterized by said one or more processing devices including being for calculating said heat (Q) transferred through the wall of said heat-exchange tube using the equation:
$$Q = \sum FXi {\int }_{{T}_{1}}^{{T}_{2}} Cpi d T$$
where
F=Total gas flow rate
Xi=mole fraction of gas component i as analyzed in line
Cpi=Heat capacity of gas component i
T₁=gas temperature at inlet of radiant zone
T₂=gas temperature at outlet of radiant zone
and calculating the skin temperature Ts of said tube using the equation:
$$Q = 2 π L ( Ts - Tg ) / ( \frac{ln \frac{ro}{ri}}{Km} )$$
where
Q=Heat transferred over the total area of the tubes calculated with equation 2
L=Total length of all the heat-exchange tubes.
Ts=Skin temperature of a tube
Tg=Temperature of the gas at the exit of a heat-exchange tube
ri=Internal radius of tube
ro=External radius of tube
Km=Thermal conductivity of tube wall provided by data from the tube supplier

12. Apparatus for determining the highest value of the skin temperature from among the temperatures of a plurality of heat-exchange tubes in a radiant zone of a fired tubular gas heater, which heater also has a first gas header located outside of said radiant zone for feeding a gas stream into said radiant zone so as to flow in separate gas streams each through a respective one of the plurality of heat-exchange tubes and a second gas header also located outside of said radiant zone for collecting said separate streams from said heat-exchange tubes in said rediant zone of said heater, by using a real-time calculation of the overall heat flux transferred through the total area of the walls of all of said heat-exchange tubes said apparatus for determining being characterized by comprising
a gas flow rate measuring device to generate a first signal indicative of the flow rate of the gas stream passing through said heat-exchange tubes,
a gas analyzer for determining the composition of said gas stream and to generate a second signal indicative of the amounts of the constituents of said gas stream;
a first temperature measuring device to generate a third signal indicative of the temperature of said gas stream before passing through said heat-exchange tubes in said radiant zone;
a second temperature measuring device to generate a fourth signal indicative of the temperature of said gas stream after passing out of said radiant zone from said heat-exchange tubes;
a plurality of temperature measuring devices to generate a plurality of fifth signals, each such fifth signal being indicative of the temperature of each separate gas stream from each respective heat-exchange tube upon exiting the radiant zone;
and one or more processing devices for selecting at least one of the values of said temperature of the gas exiting each of said heat-exchange tubes and using said value of temperature for calculating said overall heat flux and at least one skin temperature of said heat-exchange tubes.

13. Apparatus for preventing overheating of heat-exchange tubes in a tubular process gas heater, by calculating the skin temperature of a plurality of heat-exchange tubes using calculation of the overall heat flux through the walls of said heat-exchange tubes and values of gas composition and gas temperature at the inlet and at the outlet of the heat-exchange tubes characterized by comprising
temperature measuring device for periodically measuring and generating a signal indicative of the temperature of the gas flowing through each of said heat-exchange tubes at the outlet of said heat-exchange tubes, and
one or more processing devices for calculating the overall transferred heat, for selecting at least one of the measured temperatures of the gas exiting said heat-exchange tubes, for calculating the skin temperature of the corresponding tube, and for using the highest value of the calculated skin temperatures to take corrective actions to avoid tubes overheating.

14. Apparatus for determining the highest skin temperature of a plurality of heat-exchange tubes of a fired tubular gas heater according to claim 13, characterized by further comprising said one or more processing devices including being for periodically monitoring and selecting the highest temperature value of the gas exiting said heat-exchange tubes and using said highest value of the gas temperature to calculate said highest skin temperature.

15. Apparatus for determining the maximum skin temperature of heat-exchange tubes of a fired tubular gas heater according to claim 14, characterized by further comprising a said one or more processing devices including being for comparing said highest skin temperature of said heat-exchange tubes with a predetermined value of a maximum allowable operational temperature of said heat-exchange tubes, and for providing a signal when the difference between said calculated value of highest skin temperature and said maximum allowable operational temperature is equal or less than a predetermined value.

16. Apparatus for determining the maximum skin temperature of heat-exchange tubes of a fired tubular gas heater, according claim 10, wherein said temperature measuring devices are thermocouples.

17. Apparatus according to claim 15, wherein said predetermined value is between 10° C. and 15° C.
